(19) United States
(12) Patent Application Publication
(10) Pub. No.: US 2003/0236767 A1
(43) Pub. Date: Dec. 25, 2003

(54) Information processing system and information processing method

(76) Inventor: Jun Akiyama, Kashihara-shi (JP)

Correspondence Address: Dike, Bronstein, Roberts & Cushman, Intellectual Property Practice Group, Edwards & Angell, LLP, P.O. Box 9196, Boston, MA, 02209, US

(21) Appl. No.: 10/406,084

(22) Filed: Apr. 2, 2003

(30) Foreign Application Priority Data
Jun. 19, 2002 (JP) 2002-178270

(51) Int. Cl. G06F 7/00

(52) U.S. Cl. 707/1

(57) ABSTRACT

An information processing system is arranged in such a manner that a video recorder including a hard disk device storing a file, a home server including a hard disk device storing a file, and a personal computer including a storage device are interconnected via a bus. The video recorder, the personal computer, and the home server share files and each includes file management information by which a file shared in the network is associated with the information processing device storing the shared file. With this arrangement, it is possible to provide an information processing system and an information processing method, which enable to search files stored in information processing devices interconnected via a network, regardless of the ON/OFF situation of power supply to the information processing devices.

### FIELD OF THE INVENTION

The present invention relates to an information processing system an information processing method, in which a plurality of information processing devices are interconnected via a network and hence mutual use of files is realized therebetween.

### BACKGROUND OF THE INVENTION

Various types of information including images and sounds have recently been digitized, and devices for recording such types of information on disks which excel in random-accessibility have been commercialized.

For the meantime, thanks to the diffusion of communication networks, it has become common to exchange data between devices connected to a communication network.

In response to this digitization of information, Japanese Laid-Open Patent Application No. 2000-349833 (Tokukai 2000-349833; published on Dec. 15, 2000) teaches an information processing system in which digital information is inter-available through a network, exemplifying an information processing system in which a video recorder is connected to devices including a home server and a computer via a network.

Each of these information processing devices such as a video recorder, home server, and computer is provided with a storage device. This storage device can be shared between information processing devices which are interconnected via the network.

On the occasion of, for instance, storing data in a hard disk device (storage device) of the video recorder, if the space available in the hard disk device is not enough for the data, files in the device are moved to the hard disk device of another device, for instance, a home server, in order to increase the available space in the hard disk device of the video recorder. After the space required for the data is obtained in the hard disk device of the video recorder, a content such as a TV program is recorded therein.

In this case, the files are automatically moved under the control of a program of a controller of the video recorder, and on this occasion, the information concerning the destinations of the files, i.e. file management information is stored in a file management information domain of the video recorder.

This file management information domain is provided in storage devices which can keep information even if the power supply is switched off, such as hard disk devices. When it is required to use a file which has been moved, the destination of the file can be traced by reading the file management information.

What is illustrated in FIG. 6(a) is the file management information of the video recorder before the movement of a file, and in FIG. 6(b) is the file management information of the home server before the movement of the file.

As in FIG. 6(a), before the movement of a file, the video recorder stores video programs such as “Title 1” and “Title2”, and the file names thereof are “VideoFile 1” and “VideoFile2”, respectively.

As in FIG. 6(b), before the movement of the file, the home server stores video programs such as “TitleA” and “TitleB”, and the file names thereof are “VideoFileA” and “VideoFileB”, respectively.

The “Device” fields of the file management information are filled with the names of respective devices which store files. In the figure, “Recorder” indicates the video recorder and “Server” indicates the home server.

After, for instance, the file of the video program “Title2” is moved to the home server in order to increase the space available in the hard disk device of the video recorder, the file management information of the video recorder is arranged as in FIG. 7(a).

That is, the name of the device which stores “Title2” is changed to “Server”, and the name of the file is changed to “VideoFileC”. Also, as illustrated in FIG. 7(b), the information regarding “Title2” is added to the file management information of the home server.

In this manner, on the occasion of moving a file, the information concerning the destination of the file is stored in the file management information of the origin of the file, and this arrangement makes it possible to trace the destination of the file.

However, the file management information is provided only in the device of the destination and the device of the origin, i.e. provided only in the devices concerning the file movement. Thus, regarding devices whose power supply is switched off, it is not possible to obtain the file management information thereof via a network.

Moreover, when a file is automatically moved under the control of a device as described above, since the file is moved to a device which is different from the device to which the file has originally been stored, a person who has instructed the storing cannot see which device stores the file.

In this case, it is necessary to turn on all devices in order to find where the file has been moved.

Even in cases other than the automatic movement of a file for securing an available space, a file is manually moved or copied in order to share information among a personal computer, a video recorder, and a home server.

In such cases, the destination of the moved or copied file is not stored in the device of the origin.

In this manner, when a plurality of devices connected via a network share files, the file management information has not conventionally been provided in devices other than the devices concerning the file movement.

### SUMMARY OF THE INVENTION

The main objective of the present invention is to provide an information processing system and an information processing method, which enable to search files stored in information processing devices interconnected via a network, regardless of the ON/OFF situation of power supply to the information processing devices.

To solve the foregoing problem, the information processing system in accordance with the present invention, in which information processing devices each including storage means for storing files are interconnected via a network and a file is shared between the information processing devices, is arranged in such a manner that each of the information processing devices includes management information storage means for storing file management information indicating which one of the information processing devices stores the shared file.

According to this arrangement, the file management information of one information processing device on the network can be shared by a plurality of information processing devices. For this reason, it is possible to search all files stored in the information processing devices on the network from any one of the information processing devices, regardless of the ON/OFF situation of power supply to the information processing devices.

It is noted that the storage means and the management information storage means is either integrally provided or separately provided.

To solve the foregoing problem, the information processing method in accordance with the present invention is an information processing method of an information processing system in which information processing devices storing files are interconnected via a network and a file is shared between the information processing devices, using file management information indicating which one of the information processing devices stores the shared file, the information processing method comprising a file management information updating process to cause the file management information of each of the information processing devices to be identical with each other.

According to this method, even if the file management information of one information processing device on the network is shared by a plurality of information processing devices, the file management information is updated so as to be always kept up to date.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a block diagram, illustrating a substantial part of an information processing system in accordance with an embodiment of the present invention.

FIG. 2 illustrates an arrangement of a file management information of a video recorder before recording.

FIG. 3 illustrates an arrangement of the file management information of the video recorder at the time of the finish of the recording.

FIG. 4 illustrates the interaction between the video recorder and a home server in a file management information updating process on the occasion of adding a new file.

FIG. 5 illustrates the interaction between the video recorder and the home server in the file management information updating process on the occasion of turning on power.

FIG. 6(a) illustrates file management information of a video recorder of a conventional information processing system before the movement of a file, while FIG. 6(b) illustrates file management information of a home server of the conventional information processing system before the movement of the file.

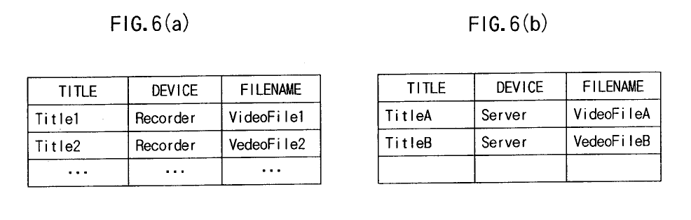

FIG. 7(a) illustrates the file management information of the video recorder of the conventional information processing system, after the movement of the file, while FIG. 7(b) illustrates the file management information of the home server of the conventional information processing system, after the movement of the file.

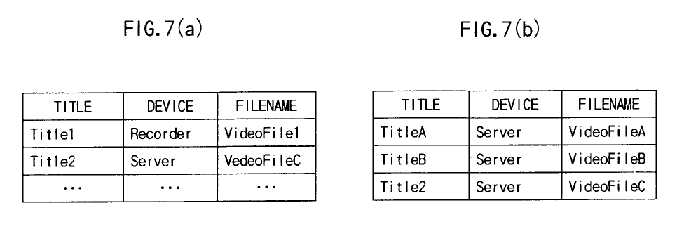

### DESCRIPTION OF THE EMBODIMENTS

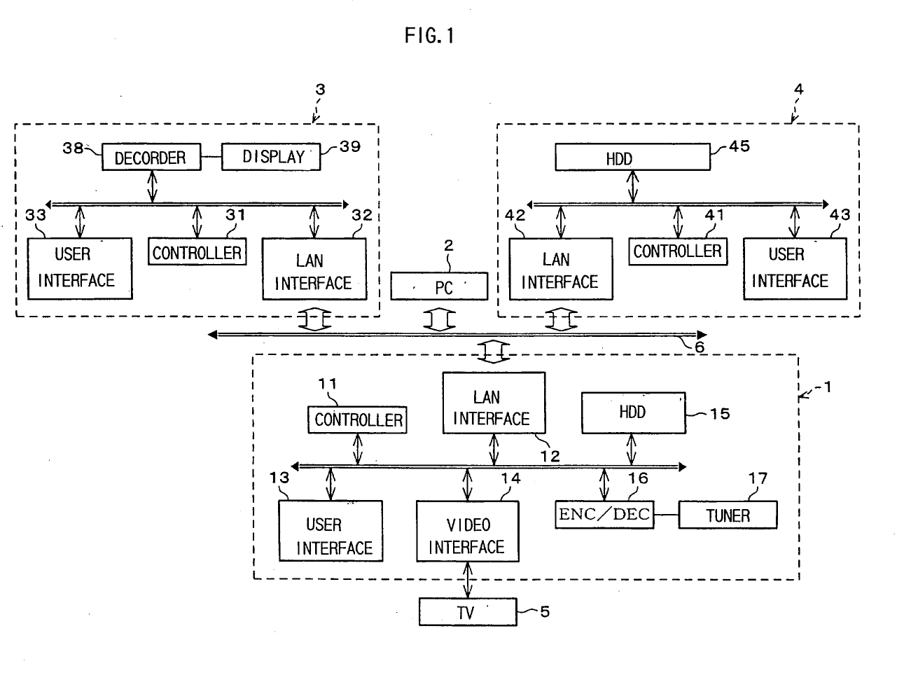

Referring to FIGS. 1-5, an embodiment of the present invention will be described as below.

FIG. 1 illustrates a substantial part of an information processing system in accordance with the present embodiment. As the figure shows, the information processing system is arranged in such a manner that a video recorder (information process device) 1, a personal computer (information processing device) 2, a display device 3, and a home server (information processing device) 4 are interconnected via a bus (communication medium, network) 6.

Any types of connection methods can be employed for constructing the bus 6, on condition that the information processing devices such as the video recorder 1, the personal computer 2, the display device 3, and the home server 4 are networked via the same. Thus, for instance, from wired methods such as Ethernet® and wireless methods such as IEEE (Institute of Electrical and Electronics Engineers) 802.11 b, an appropriate method is selected for the bus 6, considering a transfer bit rate and the installation locations of the networked devices. It is noted that a wired method and a wireless method may be used in combination.

The video recorder 1 is a device for compressing moving images such as TV programs, thereby storing the same in a device such as a built-in hard disk device (storage means, management information storage means) 15.

The video recorder 1 includes: a controller 11; a LAN (Local Area Network) interface 12; a user interface 13; a video interface 14; a hard disk device 15; and an ENC/DEC 16, which are connected to an internal bus. Further, the video recorder 1 is provided with a tuner 17 which is connected to the ENC/DEC 16.

The controller 11 collects information from blocks (interface 12, user interface 13, video interface 14, hard disk device 15, ENC/DEC 16), thereby controlling these blocks.

The LAN interface 12 is provided for connecting the video recorder 1 to the bus 6, and modifying signals and protocols to be in conformity with the bus 6.

The tuner 17 is provided for receiving a TV broadcast.

The hard disk device 15 is a storage device, for instance, converting data into a file and storing the same.

The ENC/DEC 16 compresses or decompresses moving image data by a predetermined compression method.

On the occasion of storing moving image data, an input signal to the ENC/DEC 16 is supplied from the tuner 17 or an external input terminal (not illustrated), as an analog or digital signal. The data compressed by the ENC/DEC 16 is transferred to the hard disk device 15, thereby saved (stored) as a file.

On the occasion of reproducing a moving image, the file which has been compressed is read out from the hard disk device 15, then transferred to the ENC/DEC 16 and decompressed by the same.

The video interface 14 receives moving image data which has been decompressed by the ENC/DEC 16, thereby converting the data into signals in conformity with a television 5 connected to the interface 14.

The user interface 13 is provided for transmitting the instructions, inputted by the user using a remote control and manual operation buttons, to the controller 11, and displaying the information supplied from the controller 11.

Note that, the ENC/DEC 16 may be allowed to compress/decompress still images in addition to moving images.

To the personal computer 2, a storage device (storage means, update information storage means) such as a hard disk device and an optical disk device are built in or externally connected (not illustrated).

The personal computer 2 is a device which is capable of carrying out various types of information processing, according to the types of running software. The types of information processing are typically such as web page browsing, e-mailing, word processing, printing, spreadsheet creating, image processing, moving image reproduction, sound reproduction, etc.

Further, it is possible to add or change the functions of the personal computer 2 using expansion boards. For instance, adding a tuner/video capture board enables the personal computer 2 to display TV programs and carry out the compression of moving images, and in this case the personal computer 2 can perform functions similar to those of the video recorder 1.

The home server 4 is a device for storing moving image data generated by the video recorder 1, various types of data generated by the personal computer 2, etc. as files. The home server 4 includes a controller 41, a LAN interface 42, a user interface 43, and a hard disk device (storage means, management information storage means) 45 which are connected to an internal bus.

The controller 41 collects information from blocks (LAN interface 42, user interface 43, hard disk device 45), thereby controlling these blocks.

The LAN interface 42 is provided for connecting the home server 4 to the bus 6, modifying signals and protocols to be in conformity with the bus 6.

The hard disk device 45 is provided for storing various types of information.

The user interface 43 is provided for transmitting the instructions inputted by the user using a remote control and manual operation buttons to the controller 41, and displaying the information supplied from the controller 41.

The storage devices for storing data are not limited to the hard disk devices 15 and 45 so that, for instance, an optical disk device by which data is recorded on an optical disk (recording medium) may be adopted.

Further, the user interface 43 may be arranged in such a manner that control instructions are transmitted to the home server 4 via a network, and in this case it is possible to omit the hardware for controlling.

The display device 3 is a device for displaying moving images and still images, and includes a controller 31, a LAN interface 32, a user interface 33, and a decoder 38 which are connected to an internal bus. The display device 3 is further provided with a display section 39 which displays images and connected to the decoder 38.

The controller 31 collects information from blocks (LAN interface 32, user interface 33, decoder 38), thereby controlling these blocks.

The LAN interface 32 is provided for connecting the display device 3 to the bus 6, modifying signals and protocols to be in conformity with the bus 6.

The decoder 38 is provided for decompressing files which have been compressed. For instance, on the occasion of reproducing a moving image, a compressed file is read out via the bus 6, thereby transferred to the decoder 38 and decompressed. The moving image which has been decompressed is displayed on the display section 39 connected to the decoder 38.

The compressed file may be read out from any type of device as long as a storage device is included therein. For instance, the file may be read out from the video recorder 1, personal computer 2 or home server 4.

The user interface 33 is provided for transmitting the instructions inputted by the user using a remote control and manual operation buttons to the controller 31, and displaying the information supplied from the controller 31.

It is noted that the decoder 38 is not necessarily realized by hardware, and hence may be realized by software.

By the display device 3, it is possible to view not only moving images and still images but also web pages, by displaying them on the display section 39. The processing to display them on the display section 39 can be realized using the software of the controller 31.

As described above, the information processing system in which a plurality of information processing devices each including a storage device are networked is arranged so that the storage devices of the respective information processing devices, e.g. the storage device of the personal computer 2 and the hard disk devices 15 and 45, are shared between the information processing devices. That is to say, files stored in the storage devices are inter-available (for instance, viewed and moved) to the information processing devices. A file system for this file sharing is, for instance, NFS (Network File System).

Incidentally, when, for instance, a file stored in a storage device is moved to another storage device, the destination of the file may be untraceable. For this reason, each information processing device has a file management information for managing files.

Regarding the file management information which is a characteristic feature of the present embodiment, the following will describe the arrangement and updating process thereof, and the operation of searching files using the file management information.

First, how the file management information is arranged is described.

The file management information is provided (stored) in each of information processing devices 1, 2, and 4 interconnected via a network, which have respective storage areas such as storage devices and share files. Thus, the file management information relates not only to files which are stored in the information processing device which has originally store a file and the information processing device which is the destination of the file but also to files which are stored in a plurality of information processing devices each including a storage device.

Note that, it is not necessary to share all files stored in the storage devices of the respective information processing devices 1, 2, and 4 via the network, and in most cases, it is sufficient that only some of the files stored in the storage devices of the respective information processing devices 1, 2, and 4 are shared.

For instance, the storage device of the personal computer 2 stores files concerning an OS (Operating System) for operating itself, and these files are unnecessary for the video recorder 1. Thus, these files are not necessarily shared between the information processing devices 1-4. Similarly, for instance, a file which can be reproduced only by the video recorder 1 is not necessarily shared with the personal computer 2.

In this manner, among all of the stored files, only some of them are required to be shared. For this reason, the file management information of each of the information processing devices 1, 2, and 4 only includes the information regarding some of the stored files, and this enables to reduce the amount of the file management information.

Further, the file management information may be provided in all information processing devices which are able to share files via the network. In other words, for instance, all of the information processing devices connected to the network may be provided with the file management information.

In the present embodiment, the file management information is stored in each of the storage devices of the respective information processing devices 1, 2, and 4, e.g. the storage device of the personal computer 2 and the hard disk devices 15 and 45. According to the descriptions above, files and the file management information are stored in a single storage device. However, it is possible to separately store files and the file management information in different storage areas.

Further, an information processing device using a replaceable storage medium such as an optical disk is preferably provided with a nonvolatile memory for storing the file management information regarding a storage medium which is not currently in the information processing device.

With this arrangement, it is possible to search files which are stored in storage media currently removed from information processing devices.

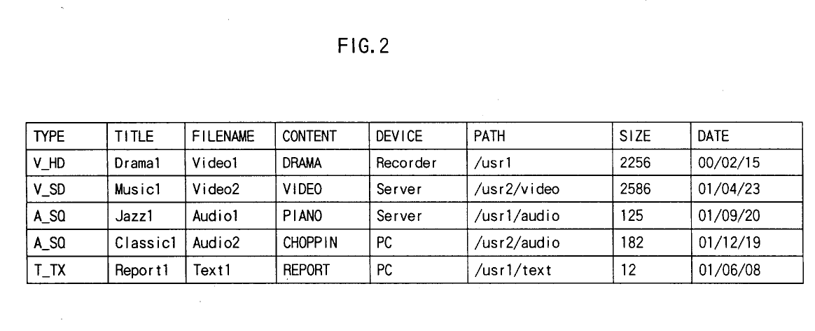

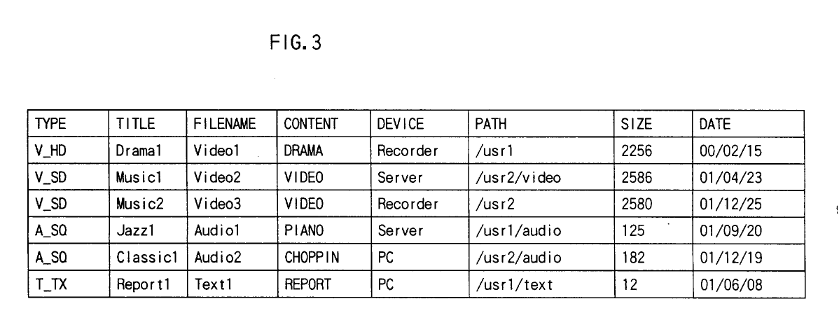

Now, the following describes an example of the arrangement of the file management information. The file management information includes at least respective sets of information (for specifying files) concerning “File Type”, “File Name”, and “Device Name”. In this example, the file management information includes respective sets of information concerning “Title”, “Content”, “Path”, “Size” and “Date” (cf. FIGS. 2 and 3) along with “File Type”, “File Name”, and “Device Name”, for the sake of convenience for searching.

The sets of information included in the file management information are not limited to any particular ones so that any types of information which are necessary or handy for file searching may be included.

As “File Type”, codes which correspond to predetermined types (categories) of files are stored. An example of the codes is illustrated in the following Table. 1.

TABLE 1

| | | |
|---|---|---|
| CATEGORIES | CODES | CONTENTS |

| | | |
|---|---|---|
| VIDEO | V_RD | HIGH-DIFINITION VIDEO |
| | V_SD | STANDARD DIFINITION |
| | | VIDEO |
| AUDIO | A_HQ | HIGH-QUALITY AUDIO |
| | A_SQ | STANDARD QUALITY AUDIO |
| | A_LQ | LENGTHY AUDIO |
| STILL IMAGE | S_JP | COMPRESSED STILL IMAGE |
| | S_BM | UNCOMPRESSED STILL |
| | | IMAGE |
| TEXT | T_TX | TEXT |
| | T_RT | TEXT WITH FORMAT |

In the example illustrated in Table. 1, the types of files are Video, Audio, Still Image, and Text. For instance, in the case of Video, if the content of a file is a high-definition video, the code is specified as V_HD.

There are following methods to put a File Type on each file: the File Type is manually inputted by the user or automatically determined by the information processing device.

Although it is not necessary to use any particular method to automatically determine the File Type, for instance, the File Type may be determined in accordance with an extension associated with the File Type, which is included in the personal computer 2, etc. as a File Name, or may be determined by analyzing the data format of a file. Alternatively, in the case of the video recorder 1, the File Type corresponds to the operation such as recording instructed by the user so that the File Type may be determined in accordance with the instruction delivered through the remote controller, etc.

It is noted that since there are many types of applications software which enable devices such as the personal computer 2 to deal with various types of files, it is preferable to assign codes to such files that are possibly dealt with, as occasion demands.

As a Title, an arbitrary name which indicates the content is stored. For instance, “Drama1” is chosen as the Title of a recorded TV program.

As a File Name, for instance, a name which has arbitrarily been provided for a file, such as “Video 1”, is stored.

As a Content, a keyword which is helpful in searching, such as drama and pop music show, is stored.

As a Device Name, the name of an information processing device which stores the file is stored.

As a Path, the path of the directory of the storage device including the file is stored. Using the Device Name and the Path enables to access the file easily, thereby reducing the time required for the access.

As a Size, the size (amount of data) of the file is stored.

As a Date, the date of creating (updating) the file is stored as a part of the file management information, and this enables to search files according to dates, for instance, searching files after October 2000.

Next, an updating process of the file management information (file management information updating process) will be described in reference to FIGS. 2-5.

In this description, the file management information illustrated in FIG. 2 is stored in each information processing device. As FIG. 2 indicates, the information processing system is arranged so that the video recorder (Recorder) 1 stores a single video file, the home server (Server) 4 stores a single video file and a single audio file, and the personal computer 2 stores a single audio file and a single text file.

In short, the file management information as illustrated in FIG. 2 stores the information regarding five files: two video files, two audio files, and one text file.

Note that, a file system necessary for the file sharing has already been set up in each information processing device, in order to cause each device to be capable of reading out files stored in other information processing devices.

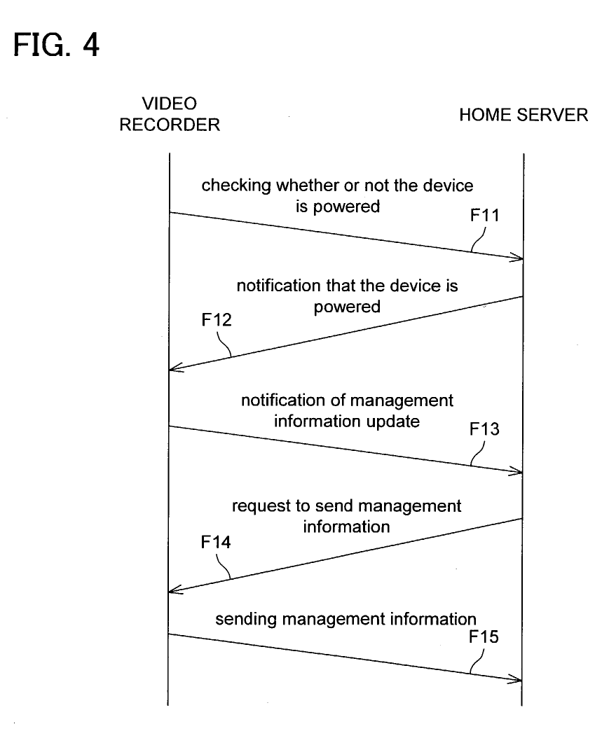

The following will describe the updating process of the file management information on the occasion of the addition of a new file, in reference to FIGS. 3 and 4. Here, the video recorder 1 newly records a TV program.

In the first instance, the video recorder 1 newly records a TV program so that a new video file is stored in the hard disk device 15 of the video recorder 1. To the file management information of the video recorder 1, a video file titled “Music2” is added as illustrated in FIG. 3. In other words, the file management information of the video recorder 1 is updated.

Note that, when a new file is added as above or a file is deleted, a Date of the file management information is altered (updated).

Then under this Date of updating the file management information, respective sets of the file management information of other information processing devices (devices other than the video recorder 1) connected to the network are updated in accordance with the following predetermined steps. In this description, the case of updating the management information of the home server 4 is discussed in reference to FIG. 4.

As FIG. 4 shows, when the file management information of the video recorder 1 is updated, the video recorder 1 checks the operating condition of the home server 4, i.e. whether or not the home server 4 is powered (F11). The home server 4 is powered in this case so that the home server 4 notifies the video recorder 1 that the device is powered (F12).

Then the video recorder 1 notifies the home server 4 that the file management information is updated (update notification process, F13 (notification of management information update))

In response to this, the home server 4 requires the video recorder 1 to send the updated file management information (F14 (requirement to send management information)). Receiving this requirement, the video recorder 1 send the updated file management information (F15 (sending of management information)).

Finally, the home server 4 updates its own file management information in accordance with the supplied file management information which has been updated in the video recorder 1 (update equalization process).

Note that, when updating the file management information using the file management information sent from another information processing device, the Date of updating to be recorded is not an actual date of updating the file management information but the Date recorded in the file management information of the video recorder 1.

Further, in this case, the aforementioned interaction between the information processing devices (cf. FIG. 4) is carried out between the controller 11 (control means) and the controller 41 (update means), and the updating process of the file management information of the home server 4 is controlled by the controller 41.

The foregoing steps are carried out between all information processing device so that the sets of the file management information of all information processing devices are updated.

Although the foregoing description relates to an example of adding a file, the updating process of file management information on the occasion of deleting a file is similarly arranged. Also, the updating process on the occasion of relocating a file can be realized by combining the file addition with the file deletion.

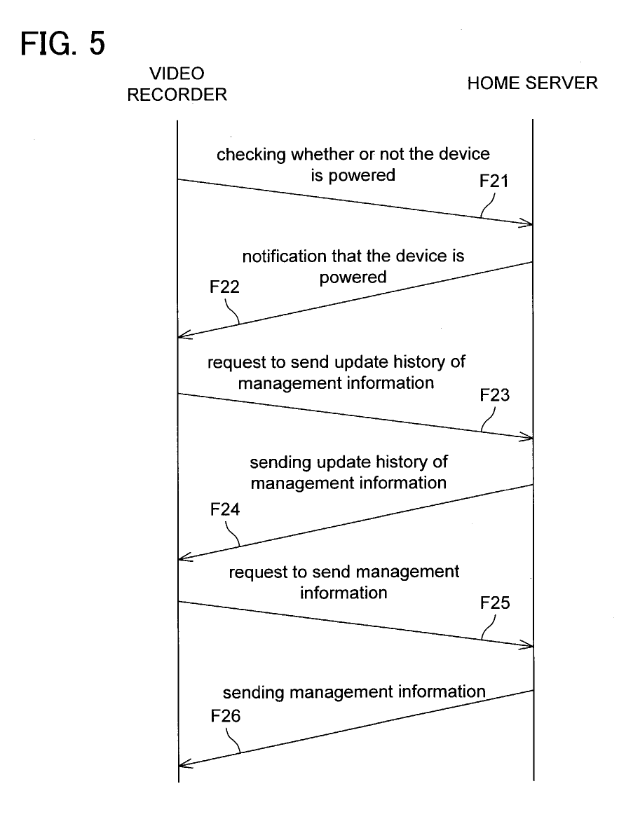

Referring to FIG. 5, the following will describe the updating process of file management information on the occasion of turning on power. This example relates to the video recorder 1, and the home server 4 is in service on the network.

First, when the video recorder 1 is turned on, initial settings necessary for the operation of the video recorder 1 are carried out by the controller 11.

Then the video recorder 1 requests other information processing devices on the network to report whether or not these devices are powered (F21). Since the home server 4 is in service in this case, the home server 4 notifies the video recorder 1 that the device is in service (F22).

In response to this, the video recorder 1 requests the home server 4 to report the update history of the file management information of the home server 4 (update history confirmation process, F23 (request of management information update history)). Then the home server 4 sends the information indicating the update history of the file management information (update history confirmation process, F24 (request of management information update history)). Here, as the information indicating the history of updating the file management information, the date of updating the file management information (latest date of updating) is supplied to the video recorder 1.

The video recorder 1 compares the date of updating supplied from the home server 4 with the date of updating the file management information, the date being stored in the video recorder 1, and the process is terminated if these dates are identical.

If the date of updating supplied from the home server 4 is more recent, the updating process (after-activation updating process) of the file management information of the video recorder 1 follows.

That is to say, the video recorder 1 subsequently requires the home server 4 to send the file management information which has been stored therein (F25). In response to this, the home server 4 sends the file management information to the video recorder 1 (F26). According to this file management information which has been sent, the video recorder 1 updates the file management information of itself.

In this example, the foregoing interaction between the information processing devices (cf. FIG. 5) is carried out between the controller 11 (update control means) and the controller 41, and the updating process of the file management information of the video recorder 1 is controlled by the controller 11.

With this arrangement, even if the file management information of an information processing device on the network is updated during the video recorder 1 is turned off, the video recorder 1 can obtain updated file management information at the moment of tuning the video recorder 1 on, thereby updating the file management information of itself.

To check the histories of updating the file management information (F23 and F24), there is such a feasible arrangement that a version number (information for specifying the history of updating) which increases in each instance of updating the file management information is included in the file management information, and the comparison is made according to this version number.

Next, the operation of searching a file using the above-mentioned file management information is described as below.

Here, the file management information of the video recorder 1 is arranged as in FIG. 2, the user carries out the operation of searching a file using a remote control, etc. adopted as the user interface 13 of the video recorder 1, and a video titled “Music 1” is searched.

If the user knows the title of a file to be searched, he/she inputs the title of the file, i.e. “Music 1”, using a remote control, etc.

In contrast, if the user does not know the title of a file to be searched, he/she inputs File Type, Content, Date, etc. as keywords, using a remote control, etc., thereby carrying out the operation of searching.

As a result, it is revealed that the File Name of the file which has been searched is “Video2” and the information processing device which stores the file is the home server 4. Since the path of the directory in the home server 4 can be obtained, it is possible to access the file.

This result of the searching is also displayed on the television 5 connected to the video recorder 1.

On this occasion, whether or not the home server 4 is in operation is checked, and if the home server 4 is not in operation (not powered), the user is notified that the home server 4 is not powered (has to be powered) through a displayed message so that the user understand that it is necessary to power the home server 4.

In response to the result of the searching, the user may input instructions, which are necessary for the reproduction by the video recorder 1, to the video recorder 1.

As described above, the information processing system in accordance with the present embodiment is arranged in such a manner that, among the information processing devices 1-4 interconnected via the bus 6, information processing devices 1, 2, and 4 which share files are each provided with a storage device for storing file management information which associates a shared file with an information processing device which stores the shared file.

With this arrangement, each of the information processing devices 1, 2, and 4 on the network includes the file management information. Thus, regardless of the ON/OFF situation of power supply to the information processing devices 1, 2, and 4, it is possible to search files on the network from any one of the information processing devices 1, 2, and 4.

Further, when the file management information of any one of the information processing devices is updated or on the occasion of activating any one of the information processing devices, the updating process of the file management information is carried out, and this makes it possible to update the respective sets of the file management information of the remaining information processing devices, even if a file is added/deleted in any one of the information processing devices or the file management information of one of the remaining information processing devices has been updated during a period that any one of the information processing devices is turned off.

As a result, all of the information processing devices have identical file management information, and hence, in the information processing system, it is possible to, for instance, search all files stored in the information processing devices on the network, from any one of the information processing devices.

As described above, the information processing system in accordance with the present invention, in which information processing devices each including storage means for storing files are interconnected via a network and a file is shared between the information processing devices, is characterized in that each of the information processing devices includes management information storage means for storing file management information indicating which one of the information processing devices stores the shared file.

According to this arrangement, the file management information of one information processing device on the network can be shared by a plurality of information processing devices. For this reason, it is possible to search all files stored in the information processing devices on the network from any one of the information processing devices, regardless of the ON/OFF situation of power supply to the information processing devices.

It is noted that the storage means and the management information storage means is either integrally provided or separately provided.

The foregoing information processing system is preferably arranged such that the file management information relates to at least one of the files stored in the information processing devices interconnected via the network.

This arrangement enables each of the information processing devices to have file management information only regarding files to be shared, i.e. files possibly used by a plurality of information processing devices.

Thus, it is possible to reduce the amount of the file management information and this allows management information storage means with a small capacity to store the file management information.

The foregoing information processing system is preferably arranged such that the file management information includes at least information indicating a type of a file, information indicating a name of a file, and information indicating a name of one of the information processing devices storing a file.

This arrangement ensures the searching of files using the file management information.

The information processing method in accordance with the present invention is an information processing method of an information processing system in which information processing devices storing files are interconnected via a network and a file is shared between the information processing devices, using file management information indicating which one of the information processing devices stores the shared file, the information processing method comprising a file management information updating process to cause the file management information of each of the information processing devices to be identical with each other.

According to this arrangement, even if the file management information of one information processing device on the network is shared by a plurality of information processing devices, the file management information is updated, thereby always kept up to date.

The foregoing information processing method is preferably arranged such that the file management information updating process is carried out when the file management information is updated in one of the information processing devices, and the file management information updating process further includes: an update notification process in which said one of the information processing devices notifies the remaining information processing devices that the file management information has been updated; and an update equalization process in which each of the remaining information processing devices updates own file management information.

According to this arrangement, even if a new file is added to or a file is deleted from one of the information processing devices, it is possible to update the file management information of each of the remaining information processing devices.

As a result, each of the information processing devices has identical file management information, and hence, for instance, the information processing system allows to search files stored in the information processing devices on the network, from any one of the information processing devices.

The foregoing information processing method is preferably arranged such that the file management information updating process is carried out when any one of the information processing devices is activated, and the file management information updating process includes: an update history confirmation process in which the activated information processing device requires the remaining information processing devices to report an update history of the file management information of each of the remaining information processing devices; and an after-activation updating process in which file management information of the activated information processing device is updated, if, according to the update history confirmation process, it is revealed that the file management information of at least one of the remaining information processing devices is updated.

According to this arrangement, when the file management information of one of the information processing devices is updated during a period that another one of the information processing devices being turned off, it is possible to update the file management information of the information processing device which has been turned off, at the time of turning the device on.

As a result, all of the information processing devices have identical file management information, and hence, in the information processing system, it is possible to, for instance, search all files stored in the information processing devices on the network, from any one of the information processing devices.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. An information processing system, in which information processing devices each including storage means for storing files are interconnected via a network and a file is shared between the information processing devices,
wherein, each of the information processing devices includes management information storage means for storing file management information indicating which one of the information processing devices stores the shared file.

2. The information processing system as defined in claim 1, wherein the file management information relates to at least one of the files stored in the information processing devices.

3. The information processing system as defined in claim 1, wherein the file management information includes at least information indicating a type of a file, information indicating a name of a file, and information indicating a name of one of the information processing devices storing files.

4. The information processing system as defined in claim 1, wherein the file management information includes information specifying an update history of a corresponding file.

5. The information processing system as defined in claim 4, wherein the information specifying the update history is either a date of updating a file or a number of times to update a file.

6. The information processing system as defined in claim 1, wherein, each of the information processing devices includes control means which has such a function that, when a file stored in that particular information processing device is updated, file management information of the particular information processing device, the file management information corresponding to the updated file, is updated, and the updated file management information is sent to the information processing devices other than the particular information processing device.

7. The information processing system as defined in claim 6, wherein, each of the information processing devices includes update means which has such a function that, receiving the updated file management information, file management information stored in the management information storage means of that particular information processing device is updated according to the received file management information.

8. The information processing system as defined in claim 4, wherein, each of the information processing devices includes update control means which requires the information processing devices other than that particular information processing device to send the information specifying the update history to the particular information processing device, after the particular information processing device is powered.

9. The information processing system as defined in claim 8, wherein, when at least one of the information processing devices other than the particular information processing device sends the information specifying the update history, which suggests that the shared file is updated before the particular information processing device is powered, the update control means of the particular information processing device requires said at least one information processing devices to send the updated file management information to the particular information processing device.

10. An information processing method of an information processing system in which information processing devices storing files are interconnected via a network and a file is shared between the information processing devices, using file management information indicating which one of the information processing devices stores the shared file,
the information processing method comprising a file management information updating process to cause the file management information of each of the information processing devices to be identical with each other.

11. The information processing method as defined in claim 10, wherein, the file management updating process is carried out when the file management information is updated in one of the information processing devices, and the file management information updating process further includes:
an update notification process in which said one of the information processing devices notifies the remaining information processing devices that the file management information has been updated; and
an update equalization process in which each of the remaining information processing devices updates own file management information.

12. The information processing method as defined in claim 10, wherein, the file management information updating process is carried out when any one of the information processing devices is activated, and the file management information updating process further includes:
an update history confirmation process in which the activated information processing device requires each of the remaining information processing devices connected via the network to report an update history of the file management information of each of the remaining information processing devices; and
an after-activation updating process in which file management information of the activated information processing device is updated, if, according to the update history confirmation process, it is revealed that the file management information of at least one of the remaining information processing devices is updated.
